(19) United States
(12) Patent Application Publication
(10) Pub. No.: US 2023/0100517 A1
(43) Pub. Date: Mar. 30, 2023

(54) OMNICHANNEL RECOMMENDATION ENGINE SYSTEMS AND METHODS

(71) Applicant: JPMORGAN CHASE BANK, N.A., New York, NY (US)

(72) Inventors: Navneet KANG, Garnet Valley, PA (US); Paul KOUROUTSIDIS, Downingtown, PA (US); Ajithkumar R NAIR, Bridgewater, NJ (US); Matthew HOKE, Audubon, NJ (US); Neville KADWA, New York, NY (US)

(21) Appl. No.: 17/484,902

(22) Filed: Sep. 24, 2021

(51) Int. Cl. G06Q 30/02; G06N 20/00

(52) U.S. Cl. CPC G06Q 30/0211; G06Q 30/0201; G06N 20/00

(57) ABSTRACT

A method may include receiving a first recommendation request context from a first communication channel; routing the first recommendation request context to a channel recommendation engine for the first communication channel; receiving a first recommendation from the channel recommendation engine for the first communication channel; providing the first recommendation and the first recommendation request context to a centralized recommendation engine that trains a machine learning engine; providing the first recommendation to the first communication channel that provides the first recommendation to the first customer; receiving a first result of the first recommendation from the first communication channel; receiving a second recommendation request context from the first communication channel; routing the second recommendation request context to the centralized recommendation engine; receiving a second recommendation from the centralized recommendation engine; and providing the second recommendation to the first communication channel that provides the second recommendation to the second customer.

### BACKGROUND OF THE INVENTION

### 1. Field of the Invention

Embodiments relate generally to omnichannel recommendation engine systems and methods.

### 2. Description of the Related Art

Customers may be provided with offers, such as offers for products, discounts, etc. online, in person, etc. Unless these offers are coordinated, a customer may be presented with the same offer twice, or may not be presented with a relevant offer.

### SUMMARY OF THE INVENTION

Omnichannel recommendation engine systems and methods are disclosed. According to one embodiment, a method may include: (1) receiving, by a recommendation interface computer program, a first recommendation request context from a first communication channel of a plurality of communication channels, wherein the first recommendation request context may include an identification of the first communication channel and an identification of a first customer that is interacting with the first communication channel; (2) routing, by the recommendation interface computer program, the first recommendation request context to a channel recommendation engine for the first communication channel; (3) receiving, by the recommendation interface computer program, a first recommendation from the channel recommendation engine for the first communication channel; (4) providing, by the recommendation interface computer program, the first recommendation and the first recommendation request context to a centralized recommendation engine, wherein the centralized recommendation engine may be configured to train a machine learning engine with the first recommendation and the first recommendation request context; (5) providing, by the recommendation interface computer program, the first recommendation to the first communication channel, wherein the first communication channel provides the first recommendation to the first customer; (6) receiving, by the recommendation interface computer program, a first result of the first recommendation from the first communication channel; (7) providing, by the recommendation interface computer program, the first result to the centralized recommendation engine, wherein the centralized recommendation engine may be configured to train the machine learning engine with the first result; (8) receiving, by the recommendation interface computer program, a second recommendation request context from the first communication channel, wherein the second recommendation request context may include the identification of the first communication channel and an identification of a second customer that is interacting with the first communication channel; (9) routing, by the recommendation interface computer program, the second recommendation request context to the centralized recommendation engine; (10) receiving, by the recommendation interface computer program, a second recommendation from the centralized recommendation engine; and (11) providing, by the recommendation interface computer program, the second recommendation to the first communication channel, wherein the first communication channel provides the second recommendation to the second customer.

In one embodiment, the method may further include receiving, by the recommendation interface computer program, a second result of the second recommendation from the first communication channel and providing, by the recommendation interface computer program, the second result to the centralized recommendation engine, wherein the centralized recommendation engine may be configured to train the machine learning engine with the first result.

In one embodiment, the method may further include: receiving, by the recommendation interface computer program, a third recommendation request context from a second communication channel of the plurality of communication channels, wherein the third recommendation request context may include an identification of the second communication channel and an identification of a third customer that may be interacting with the second communication channel; routing, by the recommendation interface computer program, the third recommendation request context to a channel recommendation engine for the second communication channel; receiving, by the recommendation interface computer program, a third recommendation from the channel recommendation engine for the second communication channel; providing, by the recommendation interface computer program, the third recommendation and the third recommendation request context to the centralized recommendation engine, wherein the centralized recommendation engine may be configured to train the machine learning engine with the third recommendation and third first recommendation request context; providing, by the recommendation interface computer program, the third recommendation to the second communication channel, wherein the second communication channel provides the third recommendation to the second customer; receiving, by the recommendation interface computer program, a third result of the third recommendation from the second communication channel; and providing, by the recommendation interface computer program, the third result to the centralized recommendation engine, wherein the centralized recommendation engine may be configured to train the machine learning engine with the third result.

In one embodiment, each of the plurality of communication channels may be associated with a channel recommendation engine.

In one embodiment, each of the plurality of communication channels may be associated with a different customer interface.

In one embodiment, the customer interfaces may include email, phone, web, and application.

In one embodiment, the method may further include verifying, by the recommendation interface computer program, that the first recommendation has not been presented to the first customer before providing the first recommendation to the first communication channel.

In one embodiment, the first result may include a behavioral event including whether the first recommendation was displayed, accepted, declined, and/or not responded to.

According to another embodiment, an electronic device may include a memory storing a recommendation interface computer program and a computer processor. When executed by the computer processor, the recommendation interface computer program causes the computer processor to: receive a first recommendation request context from a first communication channel of a plurality of communication channels, wherein the first recommendation request context may include an identification of the first communication channel and an identification of a first customer that is interacting with the first communication channel; route the first recommendation request context to a channel recommendation engine for the first communication channel; receive a first recommendation from the channel recommendation engine for the first communication channel; provide the first recommendation and the first recommendation request context to a centralized recommendation engine, wherein the centralized recommendation engine may be configured to train a machine learning engine with the first recommendation and the first recommendation request context; provide the first recommendation to the first communication channel, wherein the first communication channel provides the first recommendation to the first customer; receive a first result of the first recommendation from the first communication channel; provide the first result to the centralized recommendation engine, wherein the centralized recommendation engine may be configured to train the machine learning engine with the first result; receive a second recommendation request context from the first communication channel, wherein the second recommendation request context may include the identification of the first communication channel and an identification of a second customer that is interacting with the first communication channel; route the second recommendation request context to the centralized recommendation engine; receive a second recommendation from the centralized recommendation engine; and provide the second recommendation to the first communication channel, wherein the first communication channel provides the second recommendation to the second customer.

In one embodiment, the recommendation interface computer program may further cause the computer processor to receive a second result of the second recommendation from the first communication channel and provide the second result to the centralized recommendation engine, wherein the centralized recommendation engine may be configured to train the machine learning engine with the first result.

In one embodiment, the recommendation interface computer program may further cause the computer processor to: receive a third recommendation request context from a second communication channel of the plurality of communication channels, wherein the third recommendation request context may include an identification of the second communication channel and an identification of a third customer that is interacting with the second communication channel; route the third recommendation request context to a channel recommendation engine for the second communication channel; receive a third recommendation from the channel recommendation engine for the second communication channel; provide the third recommendation and the third recommendation request context to the centralized recommendation engine, wherein the centralized recommendation engine may be configured to train the machine learning engine with the third recommendation and third first recommendation request context; provide the third recommendation to the second communication channel, wherein the second communication channel provides the third recommendation to the second customer; receive a third result of the third recommendation from the second communication channel; and provide the third result to the centralized recommendation engine, wherein the centralized recommendation engine may be configured to train the machine learning engine with the third result;

In one embodiment, each of the plurality of communication channels may be associated with a channel recommendation engine.

In one embodiment, each of the plurality of communication channels may be associated with a different customer interface.

In one embodiment, the customer interfaces may include email, phone, web, and application.

In one embodiment, the recommendation interface computer program may further cause the computer processor to verify that the first recommendation has not been presented to the first customer before providing the first recommendation to the first communication channel.

In one embodiment, the first result may include a behavioral event including whether the first recommendation was displayed, accepted, declined, and/or not responded to.

According to another embodiment, a system may include a plurality of communication channels; a plurality of channel recommendation engines; a centralized recommendation engine; and a recommendation interface comprising a recommendation interface computer program, wherein the recommendation interface may be in communication with the plurality of communication channels, the plurality of channel recommendation engines, and the centralized recommendation engine. The recommendation interface computer program receives a first recommendation request context from a first communication channel of the plurality of communication channels, wherein the first recommendation request context may include an identification of the first communication channel and an identification of a first customer that is interacting with the first communication channel; routes first recommendation request context to one of the plurality of channel recommendation engines that may be associated with the first communication channel; receives a first recommendation from the channel recommendation engine for the first communication channel; provides the first recommendation and the first recommendation request context to the centralized recommendation engine, wherein the centralized recommendation engine may be configured to train a machine learning engine with the first recommendation and the first recommendation request context; provides the first recommendation to the first communication channel, wherein the first communication channel provides the first recommendation to the first customer, receives a first result of the first recommendation from the first communication channel; provides the first result to the centralized recommendation engine, wherein the centralized recommendation engine may be configured to train the machine learning engine with the first result; receives a second recommendation request context from the first communication channel, wherein the second recommendation request context may include the identification of the first communication channel and an identification of a second customer that is interacting with the first communication channel; routes the second recommendation request context to the centralized recommendation engine; receives a second recommendation from the centralized recommendation engine; and provides the second recommendation to the first communication channel, wherein the first communication channel provides the second recommendation to the second customer.

In one embodiment, the recommendation interface computer program may further receive a second result of the second recommendation from the first communication channel and provides the second result to the centralized recommendation engine, wherein the centralized recommendation engine may be configured to train the machine learning engine with the first result.

In one embodiment, the recommendation interface computer program may further receive a third recommendation request context from a second communication channel of the plurality of communication channels, wherein the third recommendation request context may include an identification of the second communication channel and an identification of a third customer that is interacting with the second communication channel; routes the third recommendation request context to a channel recommendation engine for the second communication channel; receives a third recommendation from the channel recommendation engine for the second communication channel; provides the third recommendation and the third recommendation request context to the centralized recommendation engine, wherein the centralized recommendation engine may be configured to train the machine learning engine with the third recommendation and third first recommendation request context; provides the third recommendation to the second communication channel, wherein the second communication channel provides the third recommendation to the second customer; receives a third result of the third recommendation from the second communication channel; and provides the third result to the centralized recommendation engine, wherein the centralized recommendation engine may be configured to train the machine learning engine with the third result;

In one embodiment, the first result may include a behavioral event including whether the first recommendation was displayed, accepted, declined, and/or not responded to.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts an omnichannel recommendation engine system according an embodiment;

FIG. 2 depicts an omnichannel recommendation engine method for using a token programmable interface according to an embodiment.

### DETAILED DESCRIPTION OF PREFERRED EMBODIMENTS

Embodiments relate generally to omnichannel recommendation engine systems and methods.

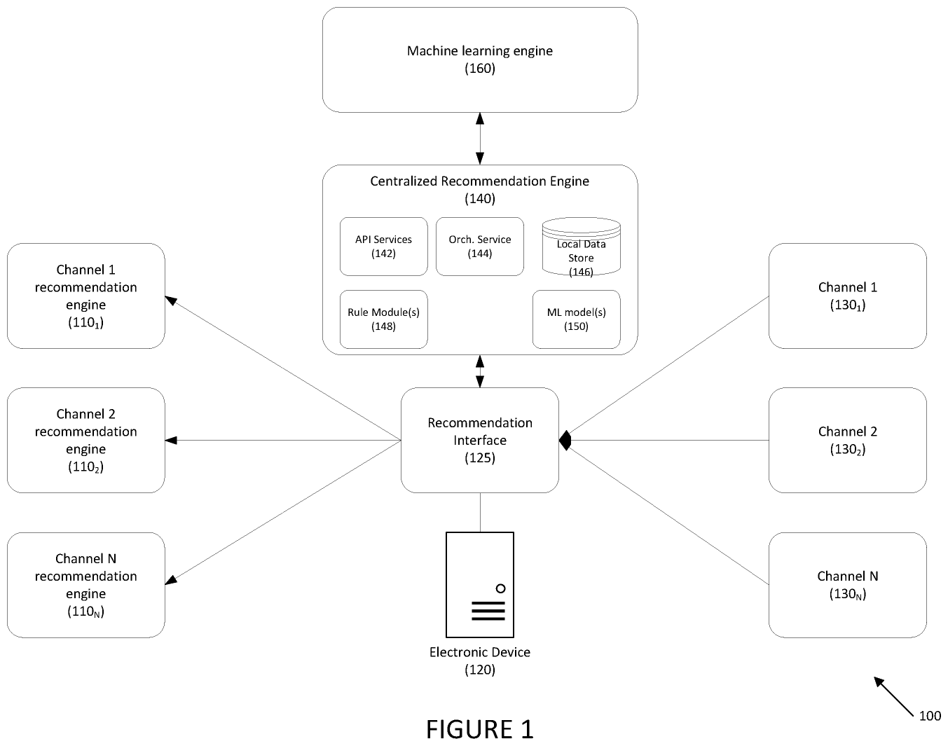

Referring to FIG. 1, an omnichannel recommendation engine is disclosed according to one embodiment. System 100 may include recommendation interface 125, which may be executed by electronic device 120, and may interface with a plurality of channels (e.g., channels 130₁, 130₂, . . . 130ₙ) and a plurality of channel recommendation engines (e.g., channel recommendation engines 110₁, 110₂, . . . 110ₙ). Examples of channels 130 include mobile, web, print, in-person, etc. In one embodiment, each channel 130 may have its own channel recommendation engine 110, or two or more channels 130 may use the same channel recommendation engine 110.

Each channel recommendation engine 110 may serve a recommendation that may be specific to its channel(s) 130.

Channel recommendation engines 110 may further interface with centralized recommendation engine 140, which may serve recommendations for all channels 130. In one embodiment, centralized recommendation engine 140 may train machine learning engine 160 with recommendations provided by channel recommendation engines 110. Once trained, machine learning engine 160 may serve recommendations to recommendation engine 140, which may then provide the recommendation to the appropriate channel 130.

In one embodiment, centralized recommendation engine 140 may include application programming interface (API) services 142, orchestration services 144, local data store 146, rule module(s) 148, and machine learning (ML) module(s) 150. API services 142 may provide an interface for channel recommendation engines 110, channels 130, etc.

Orchestration services 144 may be a program, script, etc. that is responsible for gathering required decision data, executing requisite models, executing requisite rules modules, and assembling the response back to the communication channels.

Local data store 146 may store data for centralized recommendation engine 140, such as channel data, customer data, etc.

Rule module(s) 148 may store one or more rules that may be applied by centralized recommendation engine 140. The rules may be configurable rules that may include: message eligibility, product qualification, and general suppression logic.

Machine learning models 150 may include models trained by machine learning engine 160.

In one embodiment, recommendation interface 125 may expose a restful API to channels 130 that may resemble that of the respective channel recommendation engine 110. In one embodiment, the API may be exposed using, for example, API services 142. API services 142 may accept legacy parameters for channel recommendation engines 110 that may be used until channel recommendation engines are replaced by centralized recommendation engine 130.

Recommendation interface 125 may convert disparate response types from channel recommendation engine 110 to a common format, such as JSON. Recommendation interface 125 may pull offer details associated with the recommendation from other systems as is necessary and/or desired.

In embodiment, system 100 may be hosted, on-premises, by a host financial institution or other organization. In another embodiment, some portions of system 100 may be served in, for example, a private cloud, while other portions are hosted on-premises. In embodiments, certain portions of system 100 may be provided by a third party, such as a third-party recommendation provider.

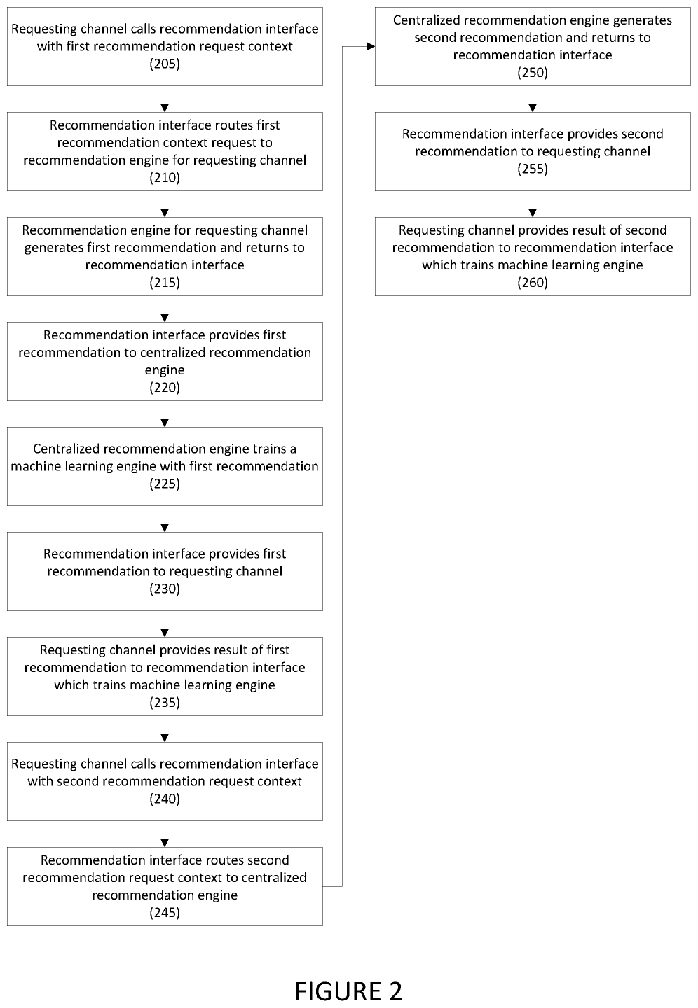

Referring to FIG. 2, a method for using an omnichannel recommendation engine is disclosed according to an embodiment.

In step 205, a requesting channel may call a recommendation interface with first recommendation request context. For example, the first recommendation request context may identify the requesting channel, the customer, and any other information that may be helpful in providing a recommendation.

In embodiments, the first recommendation request context may further include one or more parameters that may identify the recommendation being sought, placement information, etc. In embodiments, the requesting channel may pass multiple contexts in, for example, an array, depending on the type of recommendations that it is requesting.

In step 210, the recommendation interface may route the first recommendation context request to the channel recommendation engine for the requesting channel. In one embodiment, the recommendation interface may route the first recommendation request context to channel recommendation engine based on the channel and/or the context.

In step 215, the channel recommendation engine for the requesting channel may generate a first recommendation, and may return the first recommendation to the recommendation interface. In step 220, the recommendation interface may provide the first recommendation and the first recommendation request context to a centralized recommendation engine.

In step 225, the centralized recommendation engine trains a machine learning engine with the first recommendation and the first recommendation request context.

In step 230, the recommendation interface may provide the first recommendation to the requesting channel.

In step 235, the requesting channel may return the results of the first recommendation (accepted, declined, etc.) to the recommendation interface, which may train the machine learning engine with the result. For example, the results may include behavioral events, such as whether the recommendation was shown, discussed, accepted, declined, no response, etc.

In step 240, the requesting channel may call the recommendation interface with a second recommendation request context. This may be similar to step 205, above.

In step 245, the recommendation interface may route the second recommendation request context to the centralized recommendation engine.

In step 250, using the trained machine learning interface, the centralized recommendation engine may generate a second recommendation and returns the second recommendation to recommendation interface.

In one embodiment, the centralized recommendation engine may confirm that the recommendation is consistent with the channel (e.g., no paper offers for digital channels), may confirm that the recommendation has not been presented and declined on a channel other than the requesting channel, etc.

In step 255, the recommendation interface provides the second recommendation to the requesting channel.

In optional step 260, the requesting channel may return the results of the second recommendation (accepted, declined, etc.) to the recommendation interface, which may train the machine learning engine with the result.

In one embodiment, once the centralized recommendation engine is sufficiently trained, the channel recommendation engines may be disabled, disconnected, etc.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a recommendation interface computer program, a first recommendation request context from a first communication channel of a plurality of communication channels, wherein the first recommendation request context comprises an identification of the first communication channel and an identification of a first customer that is interacting with the first communication channel;
routing, by the recommendation interface computer program, the first recommendation request context to a channel recommendation engine for the first communication channel;
receiving, by the recommendation interface computer program, a first recommendation from the channel recommendation engine for the first communication channel;
providing, by the recommendation interface computer program, the first recommendation and the first recommendation request context to a centralized recommendation engine, wherein the centralized recommendation engine is configured to train a machine learning engine with the first recommendation and the first recommendation request context;
providing, by the recommendation interface computer program, the first recommendation to the first communication channel, wherein the first communication channel provides the first recommendation to the first customer;
receiving, by the recommendation interface computer program, a first result of the first recommendation from the first communication channel;
providing, by the recommendation interface computer program, the first result to the centralized recommendation engine, wherein the centralized recommendation engine is configured to train the machine learning engine with the first result;
receiving, by the recommendation interface computer program, a second recommendation request context from the first communication channel, wherein the second recommendation request context comprises the identification of the first communication channel and an identification of a second customer that is interacting with the first communication channel;
routing, by the recommendation interface computer program, the second recommendation request context to the centralized recommendation engine;
receiving, by the recommendation interface computer program, a second recommendation from the centralized recommendation engine; and
providing, by the recommendation interface computer program, the second recommendation to the first communication channel, wherein the first communication channel provides the second recommendation to the second customer.

2. The method of claim 1, further comprising:
receiving, by the recommendation interface computer program, a second result of the second recommendation from the first communication channel; and
providing, by the recommendation interface computer program, the second result to the centralized recommendation engine, wherein the centralized recommendation engine is configured to train the machine learning engine with the first result.

3. The method of claim 1, further comprising:
receiving, by the recommendation interface computer program, a third recommendation request context from a second communication channel of the plurality of communication channels, wherein the third recommendation request context comprises an identification of the second communication channel and an identification of a third customer that is interacting with the second communication channel;
routing, by the recommendation interface computer program, the third recommendation request context to a channel recommendation engine for the second communication channel;
receiving, by the recommendation interface computer program, a third recommendation from the channel recommendation engine for the second communication channel;
providing, by the recommendation interface computer program, the third recommendation and the third recommendation request context to the centralized recommendation engine, wherein the centralized recommendation engine is configured to train the machine learning engine with the third recommendation and third first recommendation request context;
providing, by the recommendation interface computer program, the third recommendation to the second communication channel, wherein the second communication channel provides the third recommendation to the second customer;
receiving, by the recommendation interface computer program, a third result of the third recommendation from the second communication channel; and
providing, by the recommendation interface computer program, the third result to the centralized recommendation engine, wherein the centralized recommendation engine is configured to train the machine learning engine with the third result.

4. The method of claim 1, wherein each of the plurality of communication channels is associated with a channel recommendation engine.

5. The method of claim 1, wherein each of the plurality of communication channels is associated with a different customer interface.

6. The method of claim 5, wherein the customer interfaces comprise email, phone, web, and application.

7. The method of claim 1, further comprising:
verifying, by the recommendation interface computer program, that the first recommendation has not been presented to the first customer before providing the first recommendation to the first communication channel.

8. The method of claim 1, wherein the first result comprises a behavioral event including whether the first recommendation was displayed, accepted, declined, and/or not responded to.

9. An electronic device, comprising:
a memory storing a recommendation interface computer program; and
a computer processor;
wherein, when executed by the computer processor, the recommendation interface computer program causes the computer processor to:
receive a first recommendation request context from a first communication channel of a plurality of communication channels, wherein the first recommendation request context comprises an identification of the first communication channel and an identification of a first customer that is interacting with the first communication channel;
route the first recommendation request context to a channel recommendation engine for the first communication channel;
receive a first recommendation from the channel recommendation engine for the first communication channel;
provide the first recommendation and the first recommendation request context to a centralized recommendation engine, wherein the centralized recommendation engine is configured to train a machine learning engine with the first recommendation and the first recommendation request context;
provide the first recommendation to the first communication channel, wherein the first communication channel provides the first recommendation to the first customer;
receive a first result of the first recommendation from the first communication channel;
provide the first result to the centralized recommendation engine, wherein the centralized recommendation engine is configured to train the machine learning engine with the first result;
receive a second recommendation request context from the first communication channel, wherein the second recommendation request context comprises the identification of the first communication channel and an identification of a second customer that is interacting with the first communication channel;
route the second recommendation request context to the centralized recommendation engine;
receive a second recommendation from the centralized recommendation engine; and
provide the second recommendation to the first communication channel, wherein the first communication channel provides the second recommendation to the second customer.

10. The electronic device of claim 9, wherein the recommendation interface computer program further causes the computer processor to:
receive a second result of the second recommendation from the first communication channel; and
provide the second result to the centralized recommendation engine, wherein the centralized recommendation engine is configured to train the machine learning engine with the first result.

11. The electronic device of claim 9, wherein the recommendation interface computer program further causes the computer processor to:
receive a third recommendation request context from a second communication channel of the plurality of communication channels, wherein the third recommendation request context comprises an identification of the second communication channel and an identification of a third customer that is interacting with the second communication channel;
route the third recommendation request context to a channel recommendation engine for the second communication channel;
receive a third recommendation from the channel recommendation engine for the second communication channel;
provide the third recommendation and the third recommendation request context to the centralized recommendation engine, wherein the centralized recommendation engine is configured to train the machine learning engine with the third recommendation and third first recommendation request context;
provide the third recommendation to the second communication channel, wherein the second communication channel provides the third recommendation to the second customer;
receive a third result of the third recommendation from the second communication channel; and
provide the third result to the centralized recommendation engine, wherein the centralized recommendation engine is configured to train the machine learning engine with the third result;

12. The electronic device of claim 9, wherein each of the plurality of communication channels is associated with a channel recommendation engine.

13. The electronic device of claim 9, wherein each of the plurality of communication channels is associated with a different customer interface.

14. The electronic device of claim 12, wherein the customer interfaces comprise email, phone, web, and application.

15. The electronic device of claim 9, wherein the recommendation interface computer program further causes the computer processor to verify that the first recommendation has not been presented to the first customer before providing the first recommendation to the first communication channel.

16. The electronic device of claim 9, wherein the first result comprises a behavioral event including whether the first recommendation was displayed, accepted, declined, and/or not responded to.

17. A system, comprising:
a plurality of communication channels;
a plurality of channel recommendation engines;
a centralized recommendation engine; and
a recommendation interface comprising a recommendation interface computer program, wherein the recommendation interface is in communication with the plurality of communication channels, the plurality of channel recommendation engines, and the centralized recommendation engine;
wherein the recommendation interface computer program receives a first recommendation request context from a first communication channel of the plurality of communication channels, wherein the first recommendation request context comprises an identification of the first communication channel and an identification of a first customer that is interacting with the first communication channel; routes first recommendation request context to one of the plurality of channel recommendation engines that is associated with the first communication channel; receives a first recommendation from the channel recommendation engine for the first communication channel; provides the first recommendation and the first recommendation request context to the centralized recommendation engine, wherein the centralized recommendation engine is configured to train a machine learning engine with the first recommendation and the first recommendation request context; provides the first recommendation to the first communication channel, wherein the first communication channel provides the first recommendation to the first customer, receives a first result of the first recommendation from the first communication channel; provides the first result to the centralized recommendation engine, wherein the centralized recommendation engine is configured to train the machine learning engine with the first result; receives a second recommendation request context from the first communication channel, wherein the second recommendation request context comprises the identification of the first communication channel and an identification of a second customer that is interacting with the first communication channel; routes the second recommendation request context to the centralized recommendation engine; receives a second recommendation from the centralized recommendation engine; and provides the second recommendation to the first communication channel, wherein the first communication channel provides the second recommendation to the second customer.

18. The system of claim 17, wherein the recommendation interface computer program further receives a second result of the second recommendation from the first communication channel and provides the second result to the centralized recommendation engine, wherein the centralized recommendation engine is configured to train the machine learning engine with the first result.

19. The system of claim 17, wherein the recommendation interface computer program further receives a third recommendation request context from a second communication channel of the plurality of communication channels, wherein the third recommendation request context comprises an identification of the second communication channel and an identification of a third customer that is interacting with the second communication channel; routes the third recommendation request context to a channel recommendation engine for the second communication channel; receives a third recommendation from the channel recommendation engine for the second communication channel; provides the third recommendation and the third recommendation request context to the centralized recommendation engine, wherein the centralized recommendation engine is configured to train the machine learning engine with the third recommendation and third first recommendation request context; provides the third recommendation to the second communication channel, wherein the second communication channel provides the third recommendation to the second customer; receives a third result of the third recommendation from the second communication channel; and provides the third result to the centralized recommendation engine, wherein the centralized recommendation engine is configured to train the machine learning engine with the third result;

20. The system of claim 17, wherein the first result comprises a behavioral event including whether the first recommendation was displayed, accepted, declined, and/or not responded to.
